(19) United States
(12) Patent Application Publication
(10) Pub. No.: US 2015/0056334 A1
(43) Pub. Date: Feb. 26, 2015

(54) BAKING KIT SYSTEM AND METHODS

(71) Applicants: Leah Tutin, Lake Oswego, OR (US); Taya Geiger, Tigard, OR (US)

(72) Inventors: Leah Tutin, Lake Oswego, OR (US); Taya Geiger, Tigard, OR (US)

(21) Appl. No.: 14/456,200

(22) Filed: Aug. 11, 2014

Related U.S. Application Data
(60) Provisional application No. 61/869,285, filed on Aug. 23, 2013.

(51) Int. Cl. A21D 8/02; A21D 10/00

(52) U.S. Cl. CPC A21D 8/02; A21D 10/002
USPC 426/87

(57) ABSTRACT

Baking kit systems and methods, and in particular, baking kit teaching systems and methods are described. in some examples, a baking kit system includes: a plurality of discretely packaged ingredients in packets configured to be mixed together into a baking mixture, the packets including lower concentration ingredient packets and higher concentration ingredient packets (being respectively of lower and higher concentrations in the baking mixture); a container for retaining the ingredient packets; and a set of instructions providing steps for combining and baking the contents of the ingredient packets. In some further examples, the packets each include an indicium and the set of instructions provides steps for combing the contents of the ingredient packets according to the indicia.

### CROSS REFERENCE TO RELATED APPLICATIONS

This application claims priority to co-pending U.S. Provisional Application Ser. No. 61/869,285, filed on Aug. 23, 2013, which is hereby incorporated by reference for all purposes.

### BACKGROUND

The present disclosure relates generally to baking kit systems and methods. In particular, baking kit systems and methods that include individually packaged ingredients having an indicium the package and instructions for an order of mixing the ingredients according to the indicium on each package are described.

Baking and cooking can be a time consuming and/or complicated process, sometimes requiring a large number of ingredients, knowledge and skill in working with the ingredients, and/or special equipment for food preparation. Baking and other food Preparation kits are generally easier to use and require less time for preparation than making baked goods and/or other food items by purchasing, measuring, and mixing each ingredient individually (i.e., “from scratch”). Further, baking and other food preparation kits reduce the need for special equipment for food preparation (e.g., measuring cups, measuring spoons, electric mixer, etc.). For example, baking kits often include a pre-mixed package a “dry” ingredients (e.g., flour, sugar, salt, baking soda, baking powder, etc.) that require addition of other “wet” ingredients (e.g., eggs, water, oil, melted butter, etc.).

Known baking kits, however, are not entirely satisfactory for the range of applications in which they are employed. For example, in baking kits including a mixture of all dry ingredients, the ingredients cannot be mixed in an optimal order and can result in uneven baking, an undesirable taste, and/or lower quality baked goods. In another example, conventional baking kits provide little or no instruction to teach and/or otherwise improve a user's baking skills. In even another example, baking kits are generally not adaptable (i.e., do not allow for one or more ingredients to be decreased or excluded), which can be desirable if the user has food allergies and/or other food preferences/requirements (e.g., vegan, diabetic, etc.).

Thus, there exists a need for baking kit systems and methods that improve upon and advance the design of known baking kits. Examples of new and useful baking kit systems and methods relevant to the needs existing in the field are discussed below.

### SUMMARY

The present disclosure is directed to baking kit systems and methods, and in particular, baking kit teaching systems and methods. In some examples, a baking kit system includes: a plurality of discretely packaged ingredients in packets configured to be mixed together into a baking mixture, the packets including lower concentration ingredient packets and higher concentration ingredient packets (being respectively of lower and higher concentrations in the baking mixture); a container for retaining the ingredient packets; and a set of instructions providing steps for combining and baking the contents of the ingredient packets. In some further examples, the packets each include an indicium and the set of instructions provides steps for combing the contents of the ingredient packets according to the indicia.

### BRIEF DESCRIPTION OF THE DRAWINGS

FIG. 1 is a front elevation view of a first example of a baking kit.

FIG. 2 is a rear elevation view of the first example of a baking kit shown in FIG. 1.

FIG. 3 is a front elevation view of an example set of ingredient packets for the first example baking kit shown in FIG. 1.

FIGS. 4A-4C are front views showing phases for making the first example of a baking kit shown in FIG. 1.

FIGS. 5-8 are perspective views showing phases for using the first example of a baking kit shown in FIG. 1.

FIG. 9 is flow chart of a first example method for making and using the first example baking kit shown in FIG. 1.

### DETAILED DESCRIPTION

The disclosed baking kit systems and methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various baking kit systems and methods are provided. Related features in the examples may be identical, similar, or dissimilar in different examples. For the sake of brevity, related features will not be redundantly explained in each example. Instead, the use of related feature names will cue the reader that the feature with related feature name may be similar to the related feature in an example explained previously. Features specific to a given example will be described in that particular example. The reader should understand that a given feature need not be the same or similar to the specific portrayal of a related feature in any given figure or example.

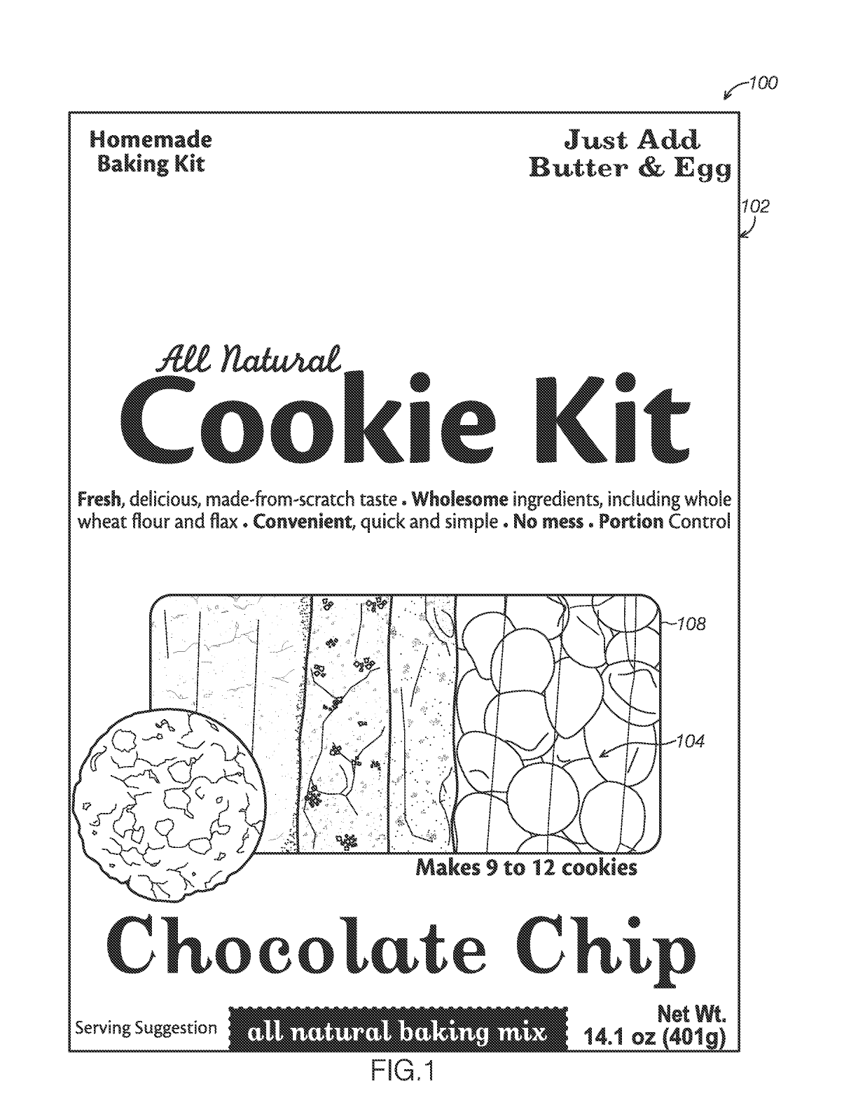

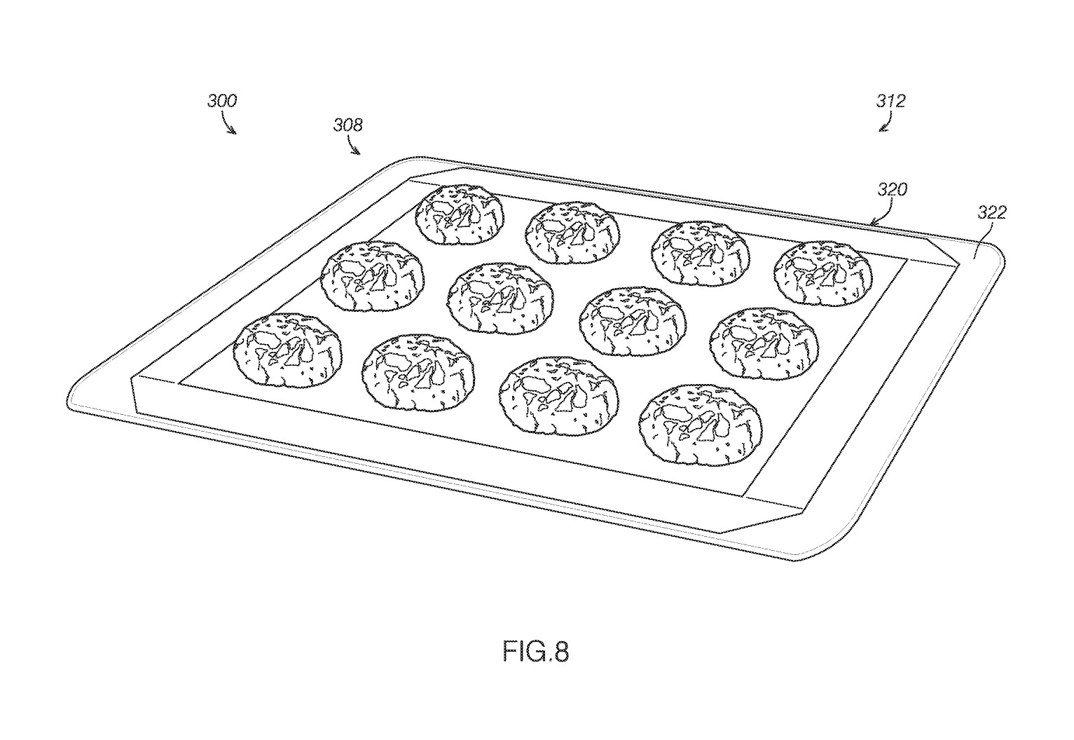

With reference to FIGS. 1-8, a first example of a baking kit system, baking kit 100, will now be described. Baking kit 100 includes a container 102, a plurality of ingredient packets 104, and a set of instructions 106. Each ingredient packet includes a specific desired amount of a discretely packaged ingredient (i.e., a specific weight-measured amount of a single ingredient). Further, each ingredient packet includes an indicium (e.g., indicia 118c-132c). Set of instructions 106 provides instructions for combining and/or mixing ingredients in a specific order according to the indicia.

Baking kit 100 functions to provide a kit for baking that is easier to use and requires less time for preparation than making baked goods “from scratch”. For example, baking kit 100 requires less equipment for baked good preparation (i.e., a bowl, a utensil, and a baking sheet). In another example, a time required for acquiring ingredients at a grocery store is reduced and/or a time required for measuring ingredients is reduced.

Unlike conventional baking kits, however, baking kit 100 provides each ingredient in a separately sealed packet (i.e., package). Because each ingredient is separately packaged, a user can easily exclude, reduce, and/or substitute one or more ingredients as desired to suit taste and/or dietary restrictions. Further, because each ingredient is separately packaged, a user can add each ingredient in a specific order (e.g., lower concentration ingredients dissolved in liquid prior to adding higher concentration ingredients, flour added last, etc.) that results in even baking, better taste, and/or higher quality hacked goods. Additionally or alternatively, baking kit 100 can be used to teach and/or improve baking skills.

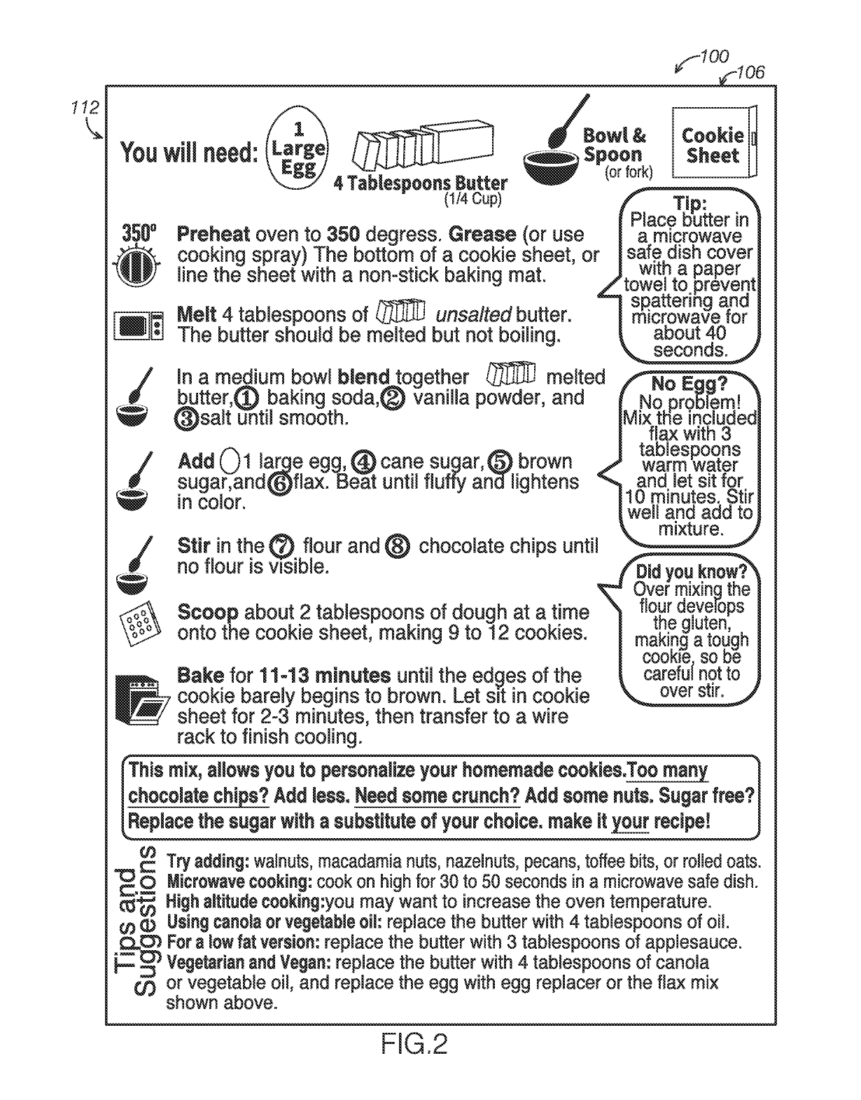

As can be seen in FIGS. 1 and 2, baking kit 100 includes container 102 having a window 108. in the present example, container 102 is a cardboard box having a front panel 110 (shown in FIG. 1), a rear panel 112 (shown in FIG. 2), top and bottom panels (not specifically shown) and right and left panels (not specifically shown). Front panel 110 includes window 108. Plurality of ingredient packets 104 are viewable through window 108 and container 102 is configured to retain plurality of ingredient packets 104. Front panel 110 can further include descriptors and/or logos. In the present example, rear panel 112 includes set of instructions 106.

In other examples, the container can be comprised of a different material, such as plastic. Additionally or alternatively, the container can have more or fewer windows in either of the front and back panels. Further, in some other examples, the set of instructions can be printed on a separate sheet and included inside of the box. In these examples, the rear panel can include nutritional information, descriptors, and/or logos. Furthermore, top, bottom, right, and left panels can include instructions, nutritional information, descriptors, and/or logos.

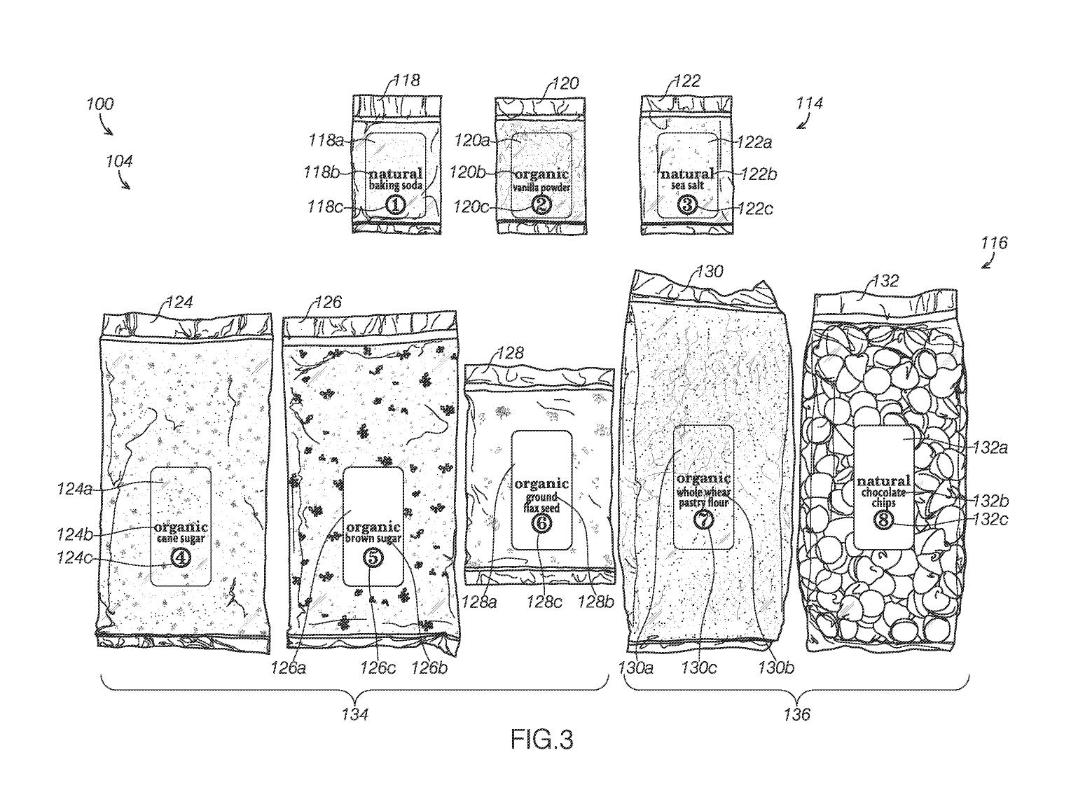

As shown in FIG. 3, plurality of ingredient packets 104 includes a plurality of lower concentration ingredients 114 and a plurality of higher concentration ingredients 116. Each of the plurality of ingredient packets contain discrete contents configured to be mixed into a baking mixture. Lower concentration ingredients 114 are defined as “lower concentration” because they are of a lower concentration in the final baking mixture (i.e., all of the ingredients mixed together). Higher concentration ingredients 116 are defined as “higher concentration” because they are of a higher concentration in the final baking mixture.

In the present example, lower concentration ingredients 114 include a baking soda packet 118, a vanilla powder packet 120, and a salt packet 122. Higher concentration ingredients 116 include a cane sugar packet 124, a brown sugar packet 126, a flax packet 128, a flour packet 130, and a chocolate chips packet 132. In other examples, the lower concentration ingredients can include other lower concentration ingredients (e.g. baking powder, fine sea salt, cinnamon, cream of tartar, etc.) and higher concentration ingredients can include other higher concentration ingredients (e.g., cocoa, walnuts, peanuts, almonds, powdered sugar, etc.).

In the present example, the ingredients of baking kit 100 can be combined with other ingredients butter and/or oil, egg, etc.) and baked to make chocolate chip cookies. In other examples including different ingredients, the ingredients of a baking kit can be combined and baked to make other baked goods. In some examples, the baking kit can be used to make oatmeal raisin cookies, peanut butter cookies, chocolate truffle cookies, sugar cookies, snickerdoodle cookies, ginger snap cookies, shortbread cookies, brownies, pound cake, angel food cake, chocolate cake, vanilla cake, red velvet cake, blueberry muffins, apple muffins, bran muffins, croissants, pie crust, or any other baked good known or yet to be discovered.

It be appreciated that in some examples, additional ingredient packets can be included that are used post-baking and/or are not otherwise added to the baking mixture. For example, a baking kit can include an additional ingredient (e.g., a course seal salt packet a decorating sugar packet, cinnamon powdered sugar, etc.) for sprinkling on the top of baked goods after they are baked and/or after the dough is partitioned or otherwise prepared for baking. In another example, an additional ingredient (e.g., vanilla powder, powdered sugar, etc.) can be included in a baking kit for creating a separate mixture, such as frosting mixture, which can be added to baked goods after baking.

Returning to FIG. 3, each of ingredient packets 104 (e.g., packets 118-132) is comprised of a sealable plastic and includes a label (e.g., labels 118a-132a) having a printed ingredient name (e.g., printed names 118b-132b) and an indicium (e.g., indicia 118c-132c). In the present example, the indicia include a number. In other examples, the indicia include a color. In even other examples, the indicia include a number and a color.

As shown in FIG. 3, packets 118-122 contain lower concentration ingredients (i.e., lower concentration ingredient packets 114). Packet 118 includes a pre-measured amount of baking soda and has a label 118a having printed name 118b reading “natural baking soda” and an indicium 118c having a “1” within a circle. Further, packet 120 includes a pre-measured amount of vanilla powder and has a label 120a having printed name 120b reading “organic vanilla powder” and an indicium 120c having a “2” within a circle. Furthermore, packet 122 includes a pre-measured amount of sea salt and has a label 122a having printed name 122b reading “natural sea salt” and an indicium 122c having a “3” within a circle. In some examples, indicium 118c-122c include a first color (e.g., blue coloration) in the circles.

Also depicted in FIG. 3, packets 124-132 contain higher concentration ingredients that are resistant to agitation during stirring (i.e., higher concentration ingredients 116). More specifically, packets 124-128 contain higher concentration ingredients that are resistant to agitation during stirring (i.e., higher concentration ingredient packets resistant to agitation during stirring 134) and packets 130 and 132 contain higher concentration ingredients that are sensitive to agitation during stirring (i.e., higher concentration ingredient packets sensitive to agitation during stirring 136).

As shown in FIG. 3, packet 124 includes a pre-measured amount of cane sugar and has a label 124a having printed name 124b reading “organic cane sugar” and an indicium 124c having a “4” within a circle. Further, packet 126 includes a pre-measured amount of brown sugar and has a label 126a having printed name 126b reading “organic brown sugar” and an indicium 126c having a “5” within a circle. Furthermore, packet 128 includes a pre-measured amount of flax seed and has a label 128a having printed name 128b reading “organic ground flax seed” and an indicium 128c having a “6” within a circle. In some examples, indicium 124c-128c include a second color (e.g., a red coloration) filling in the circles.

Additionally, as depicted FIG. 3, packet 130 includes a pre-measured amount of flour and has a label 130a having printed name 130b reading “organic whole wheat pastry flour” and an indicium 130c having a “7” within a circle. Further, packet 132 includes a pre-measured amount of chocolate chips and has a label 132a having printed name 132b reading “natural chocolate chips” and an indicium 132c having a “8” within a circle. In some examples, indicium 130c and 132c include a third color (e.g., a green coloration) filling in the circles.

The numbers and/or colors of the indicia correspond to steps in the set of instructions for adding/combining the ingredients according to a specific order. In the present example, the ingredient packets are sequentially numbered and the set of instructions includes steps for combining the contents in an ascending numerical order. In other examples, the ingredient packets are color-coded and the set of instructions includes steps for combining the contents according to a color order (e.g., lower concentration ingredient packets haying a first color and higher concentration ingredient packets having a second color, the instructions including steps for combining the contents in a color order where the first color is first and the second color is second, etc.). In even other examples, the contents of the ingredient packets can be combined according to a numerical order and a color order.

It can be advantageous to include both a numerical order and a color order in the indicia and the set of instructions, particularly if young children are using the baking kit. In some cases the children may know and/or recognize colors but may not know and/or recognize numbers. In other cases, children may be learning numbers and the baking kit can be a tool for reinforcing number learning. In addition to teaching colors and numbers for young children, the baking kit can be used to teach older children and/or adults improved methods for baking (e.g., addition of lower concentration ingredients to a liquid prior to adding higher concentration ingredients, addition of higher concentration ingredients that are sensitive to agitation by stirring otter mixing other ingredients, etc.).

It will be appreciated that in examples including additional ingredient packets that are used post-baking and/or are not otherwise added to the baking mixture, the additional ingredients can have a different coloration and higher numbering than other ingredients. For example, a baking kit can include an additional ingredient (e.g., a course seal salt packet, a decorating sugar packet, cinnamon, powdered sugar, etc.) for sprinkling on the top of baked goods after they are baked and/or alter the dough is partitioned or otherwise prepared for baking that has a yellow colored and a higher number indicia than the higher concentration ingredients. In another example, an additional ingredient (e.g., vanilla powder, powdered sugar, etc.) can be included in a baking kit for creating a separate mixture, such as frosting mixture, which can added to baked goods after baking that has a pink colored and a higher number indicia than the higher concentration ingredients.

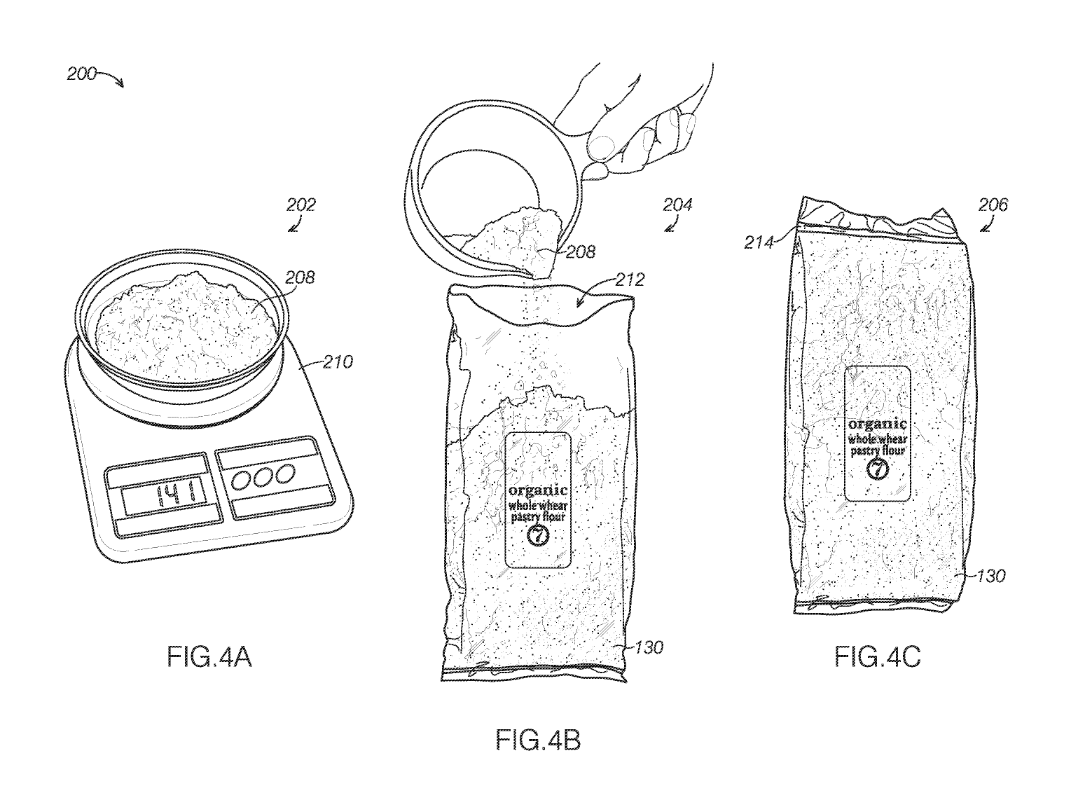

Turning now to FIGS. 4A-4C, an example packet preparation process 200 (i.e., packet preparation phases 202-206) is shown. As shown in FIG. 4A, at measuring phase 202 a single pure ingredient 208 (e.g., flour) is measured using a scale 210. As shown in FIG. 4B, at packaging phase 204 ingredient 208 is poured, scooped, and/or otherwise inserted into an open top end 212 of a packet (e.g., packet 130). At sealing phase 206 show in FIG. 4C, open top end 212 is sealed to create an air-tight sealed top end 214 of a packet (e.g., packet 130).

In the present example, ingredients are measured by weight. In other examples, ingredients can be additionally or alternatively measured by volume. It will be appreciated that although the example packet preparation process is shown only for packet 130, other ingredient packets are prepared in a substantially similar process. It will be further appreciated that measuring can be performed in separate stages for each ingredient (i.e., measuring equipment and measuring area sterilized between measurement of each ingredient) and/or measuring can be performed in separate facilities for each ingredient to prevent cross-contamination.

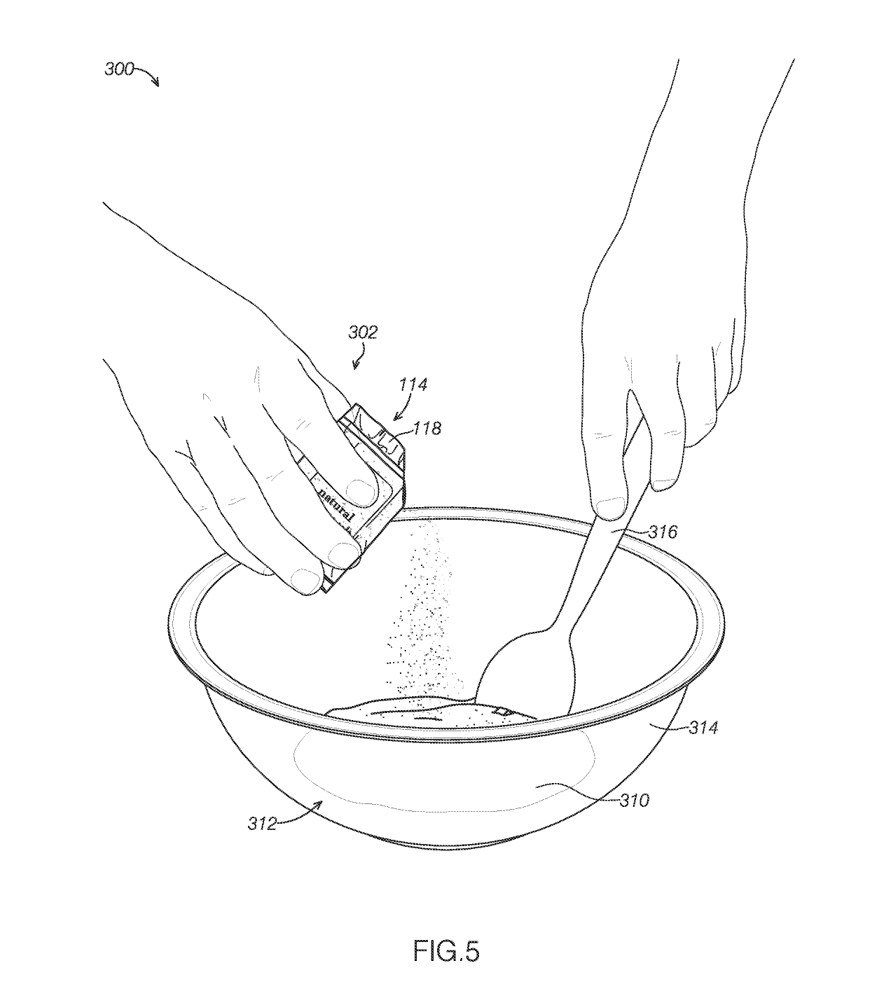

An example baked good preparation process 300 (i.e., baked good preparation phases 302-308) is shown in FIGS. 5-8. First, as depicted in FIG. 5 at lower concentration ingredient mixing phase 302, lower concentration ingredients, such as the contents of packet 118, are mixed with oil and/or melted butter 310. It will be appreciated that although only the contents of ingredient packet 118 (i.e., baking soda) is depicted being mixed with oil and/or melted butter 310, other lower concentration ingredients are added to baking mixture 312 at phase 302. In the present example, contents having numbered indicia 1-3 and/or blue indicia on the packets (i.e., ingredient packets 118, 120, and 122) are added to baking mixture 312. Ingredients are mixed in a bowl 314 with a utensil 316, In phase 302, lower concentration ingredients are mixed into a liquid (e.g., oil and/or melted butter) until they become evenly distributed through the liquid mixture.

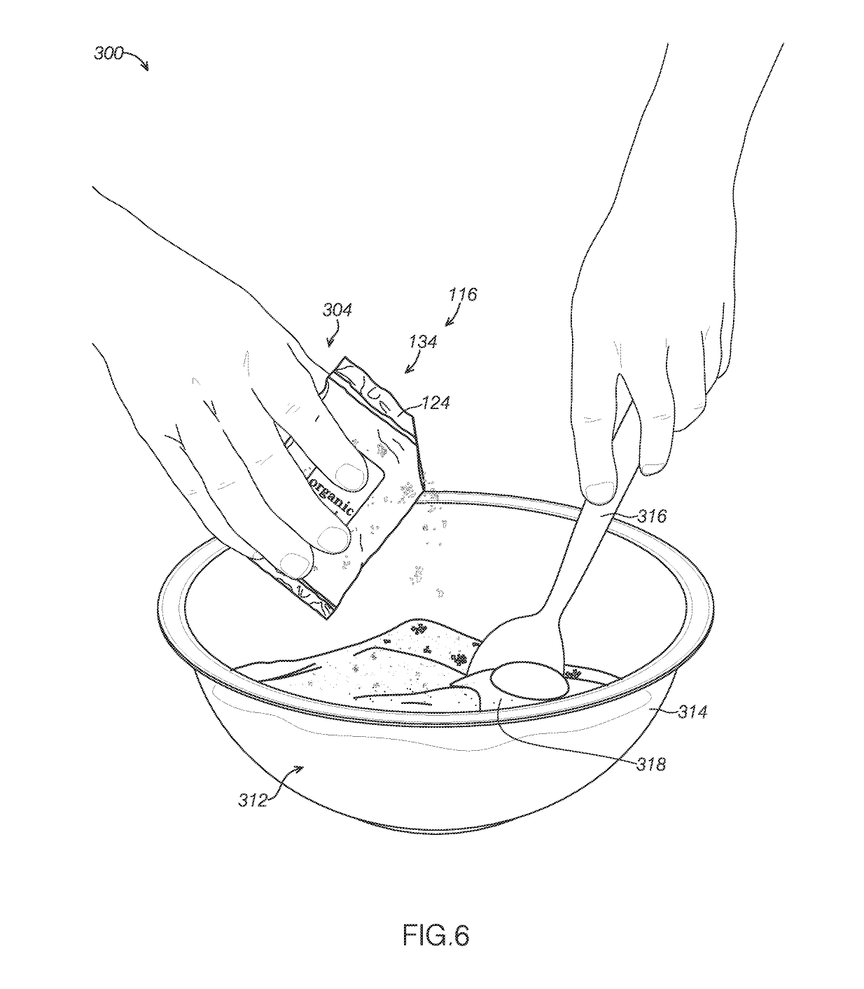

After mixture of lower concentration ingredients, at first higher concentration. ingredient mixing phase 304 depicted in FIG. 6, higher concentration ingredients that are resistant to agitation by stirring, such as the contents of packet 124, are added to baking mixture 312 with egg 318. It will be appreciated that although only the contents of ingredient packet 124 organic cane sugar) is depicted being added to baking mixture 312, other higher concentration ingredients that are resistant to agitation by stirring are added to baking mixture 312 at phase 304. In the present example, contents having numbered indicia 4-6 and/or red indicia on the packets ingredient packets 124, 126, and 128) are added to baking mixture 312. Ingredients are mixed in a bowl 314 with a utensil 316. In phase 304, higher concentration ingredients that are resistant to agitation by stirring are stirred into the mixture until they are evenly distributed in the baking mixture.

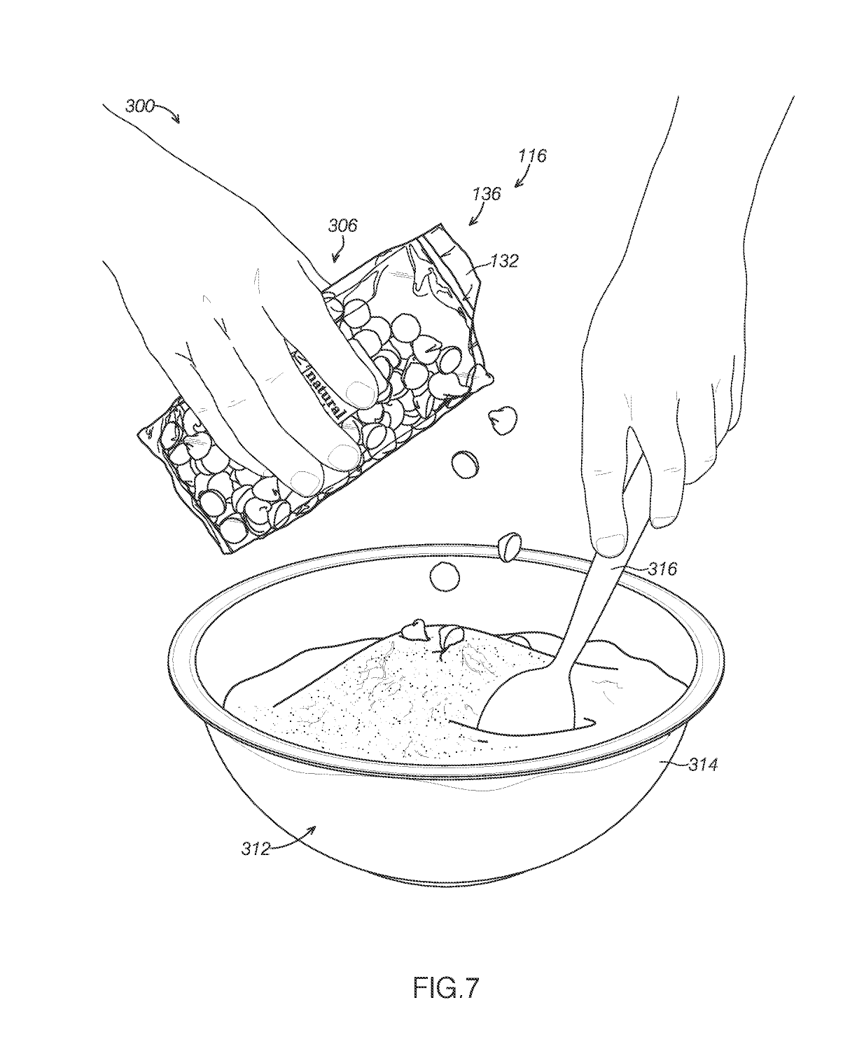

Next, as depicted in FIG. 7 at second higher concentration ingredient mixing phase 306, higher concentration ingredients that are sensitive to agitation by stirring, such as the contents of packet 132, are added to baking mixture 312. It will be appreciated that although only the contents of ingredient packet 132 (i.e., chocolate chips) is depicted being added to baking mixture 312 other higher concentration ingredients that are sensitive to agitation by stirring are added to baking mixture 312 at phase 306. In the present example, contents having numbered indicia 7 and 8 and/or green indicia on the packets (i.e., ingredient packets 130 and 132) are added to baking mixture 312. Ingredients are mixed in a bowl 314 with a utensil 316. In phase 306, higher concentration ingredients that are sensitive to agitation by stirring are stirred into the mixture until they are evenly distributed in the baking mixture.

It is advantageous to add ingredients that are sensitive to agitation last in the mixture so that they undergo a minimal amount of stirring. For example, it is advantageous to add flour after mixing in other ingredient to prevent overworking of the gluten in the flour. Overworking elongates the gluten strands, creating a baked good that is tough, rather than light, crumbly, and/or flaky. In another example, it is advantageous to add chocolate chips and/or nuts after mixing other ingredients to limit breaking of the chips and/or nuts during the mixing process. It will be appreciated that some example baked goods contain no ingredients that are sensitive to agitation by stirring (e.g., baked goods including gluten free flour) and in these examples, all higher concentration ingredients can be added in one phase/step.

Finally, as depicted in baking phase 308, baking mixture 312 is separated into individual sections of dough 320 and placed on a baking sheet 322. In some examples, baking sheet 322 is a disposable baking sheet that is included a baling kit 100. In other examples, baking sheet 322 is a non-disposable baking sheet that is supplied by the user. Baking sheet 322 with sections of dough 320 is then heated to bake the dough into the final baked good product. The dough can be heated in any of a microwave, a toaster oven, a solar oven, and/or a convection oven.

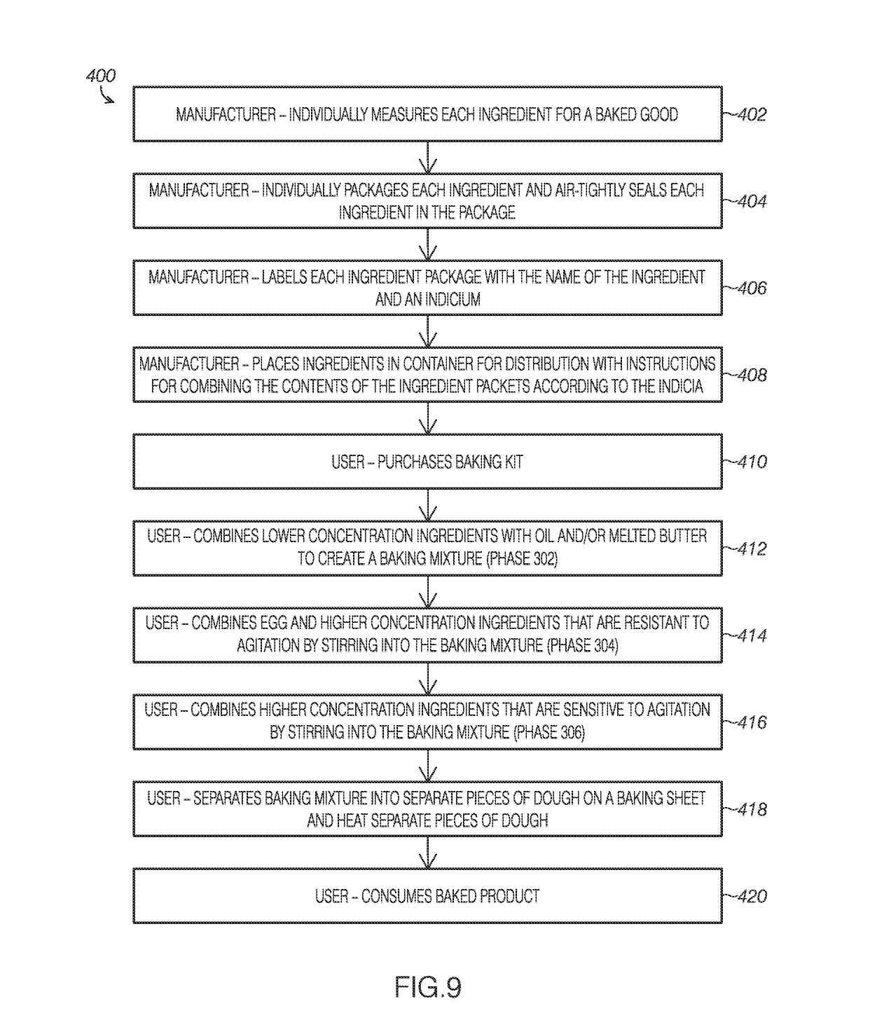

Turning attention to FIG. 9, a method 400 making and using baking kit 100 will now be described. Method 400 includes steps 402-408 for making baking kit 100 (i.e., steps performed by a manufacturer) and steps 410-420 for using baking kit 100 (i.e., steps performed by a user).

First at step 402, each ingredient is individually measured by weight and/or volume by the manufacture (phase 202). Each measured ingredient is then inserted into a package and the package is sealed by an air-tight seal, at step 404 (phases 202 and 204). Each packet is then labeled with the ingredient name and an indicium (e.g., a number and/or a coloration). Lastly, for making the baking kit, the manufacturer inserts the ingredient packets into a container with instructions for combining the contents of the ingredient packets in a specific order according to the indicia at step 408.

At step 410, a user purchases the baking kit. When baking is desired, the user then combines the lower concentration ingredients with oil and/or melted butter at step 412 (phase 302). Next, at step 414, egg and higher concentration ingredients that are resistant to agitation by stirring are combined into the baking mixture (phase 304). step 416, the user combines higher concentration ingredients that are sensitive to agitation by stirring into the baking mixture (phase 306). The baking mixture is then separated into separate pieces of dough on a baking sheet and heated (phase 308) at step 418. Finally, the baked good product is obtained and/or consumed at step 420.

It will be appreciated that the method described above is one example method, and the method may vary depending on the specific baked good product. For example, if the baking kit is a baking kit for a cake, the baking mixture is poured into a pan and heated, rather than separating the baking mixture into separate pieces. In another example, if an alternative non-gluten flour is included in the baking kit rather than conventional flour, the flour can be added with the higher concentration ingredients that are resistant to agitation by stirring. In even another example, one or more of the ingredients can be substituted, reduced, and/or excluded depending on the desired taste and/or dietary restrictions of the user.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may he claimed through amendment of those claims or presentation of new claims in the present application or in a related application. Such amended or new claims, whether they are directed to the same invention or a different invention and whether they are different, broader, narrower or equal in scope to the original claims, are to he considered within the subject matter of the inventions described herein.

1. A baking kit system, comprising:
a plurality of discretely packaged ingredients substantially being a plurality of ingredient packets each having discrete contents configured to be mixed into a baking mixture, the plurality of ingredient packets being at least:
one or more lower concentration ingredient packets each enclosing a lower concentration ingredient, the lower concentration ingredient being of a lower concentration in the baking mixture, and
one or more higher concentration ingredient packets each enclosing a higher concentration ingredient, the higher concentration ingredient being of a higher concentration in the baking mixture;
a container configured to retain the plurality of ingredient packets; and
a set of instructions providing a series of steps for combining and baking the discrete contents of the plurality of ingredient packets.

2. The baking kit system of claim 1, further comprising an indicium on each of the plurality of ingredient packets.

3. The baking kit system of claim 2, wherein the indicium is a number and each of the plurality of ingredient packets is sequentially numbered, and
wherein the set of instructions comprises steps for combining the discrete contents of the plurality of ingredient packets into the baking mixture according to a numerical order.

4. The baking kit system of claim 3, wherein the one or more lower concentration ingredient packets have a lower number and the one or more higher concentration ingredient packets have a higher number, the numerical order being an ascending numerical order.

5. The baking kit system of claim 4, wherein the one or more higher concentration ingredient packets comprise one or more ingredient packets with contents that are resistant to agitation by stirring and one or more ingredient packets with contents that are sensitive to stirring, the one or more ingredient packets with contents that are resistant to agitation by stirring having a lower number than the one or more ingredient packets with contents that are sensitive to stirring.

6. The baking kit system of claim 2, wherein the indicium is a color and each of the plurality of ingredient packets is color-coded, and
wherein the set of instructions comprises steps for combining the discrete contents of the plurality of ingredient packets according to a color order.

7. The baking kit system of claim 6, wherein the one or more lower concentration ingredient packets have at least a first color and the one or more higher concentration ingredients have at least a second color, the color order firstly comprising the first color and secondly comprising the second color.

8. The baking kit system of claim 7, wherein the one or more higher concentration ingredient packets comprise one or more ingredient packets with contents that are resistant to agitation by stirring and one or more ingredient Packets with contents that are sensitive to stirring, the one or more ingredient packets with contents that are resistant to agitation by stirring having the second color and the one or more ingredient packets with contents that are sensitive to stirring having a third color, the color order thirdly comprising the third color.

9. The baking kit system of claim 1, wherein the set of instructions comprises steps for combining contents of the one or more lower concentration ingredient packets with a liquid prior to combining contents of the one or more higher concentration ingredient packets.

10. The baking system of claim 1, wherein the liquid is one or more of melted butter and oil,
wherein the one or more lower concentration ingredient packets are one or more of a packet of baking soda, a packet of baking powder, a packet of vanilla powder, and a packet of salt, and
wherein the one or more higher concentration ingredient packets are one or more of a packet of flour, a packet of cane sugar, a packet of brown sugar, and a packet of flax.

11. The baking kit of claim 1, wherein each of the discrete contents in each of plurality of ingredient packets is provided in a pre-measured amount.

12. The baking kit of claim 11, wherein the pre-measured amount is measured by weight.

13. The baking kit of claim 1, wherein each of the discrete contents in each of the plurality of ingredient packets is a single baking ingredient.

14. The baking kit of claim 1, wherein the set of instructions is adaptable to exclude one or more of the discrete contents contained within the plurality of ingredient packets from the baking mixture.

15. The baking kit of claim 1, wherein each of the plurality of ingredient packets comprises an air tight seal enclosing the discrete contents.

16. A baking kit teaching system, comprising:
a plurality of discretely packaged ingredients substantially being a plurality of ingredient packets each having discrete contents configured to be mixed into a baking mixture, each of the plurality of ingredient packets having an indicium, the indicium indicating an order for adding the discrete contents of each of the plurality of ingredient packets to the baking mixture, the plurality of ingredient packets being at least:
one or more lower concentration ingredient packets each enclosing a lower concentration ingredient, the lower concentration ingredient being of a lower concentration in the baking mixture, and
one or more higher concentration ingredient Packets each enclosing higher concentration ingredient, the higher concentration ingredient being of a higher concentration in the baking mixture;
a container configured to retain the plurality of ingredient packets; and
a set of instructions providing a series of steps for combining and baking the discrete contents of the plurality of ingredient packets according to the indicium on each of the plurality of ingredient packets.

17. The baking kit teaching system of claim 16, wherein the indicium is a number and the set of instructions comprises steps for adding the discrete contents of each of the plurality of ingredient packets into the baking mixture according to an ascending numerical order, and
wherein each of the one or more lower concentration ingredient packets has a lower number and each of the one or more higher concentration ingredient packets has a higher number.

18. The baking kit teaching system of claim 16, wherein the indicium is a color and the set of instructions comprises steps for adding the discrete contents of each of the plurality of ingredient packets into the baking mixture according to a color order, and
wherein each of the one or more lower concentration ingredient packets has a first color and each of the one or more higher concentration ingredients has a second color, the color order firstly comprising the first color and secondly comprising the second color.

19. The baking kit teaching system of claim 16, wherein each of the discrete contents in each of the plurality of ingredient packets is provided in pre-measured amount that is measured by weight, and
wherein each of the plurality of ingredient packets comprises an air tight seal enclosing the discrete contents, each of the discrete contents being a single baking ingredient.

20. A baking kit teaching system, comprising:
a plurality of discretely packaged ingredients substantially being a plurality of ingredient packets each having discrete contents configured to be mixed into a baking mixture, each of the discrete contents in each of the plurality of ingredient packets being provided in pre-measured amount that is measured by weight, each of the plurality of ingredient packets providing an air tight seal enclosing the discrete contents, each the discrete contents being a single baking ingredient, the plurality of ingredient packets being at least:
one or more lower concentration ingredient packets each enclosing a lower concentration ingredient, the low concentration ingredient being of a lower concentration in the baking mixture, and
one or more higher concentration ingredient packets each enclosing a higher concentration ingredient, the higher concentration ingredient being of a higher concentration in the baking mixture;
a container configured to retain the plurality of ingredient packets; and
a set of instructions providing a series of steps for combining and baking the discrete contents of the plurality of ingredient packets,
wherein each of the plurality of ingredient packets has an indicium, the indicium indicating an order for adding the discrete contents of each of the plurality of ingredient packets to the baking mixture,
wherein the indicium is a number and a color, and the set of instructions comprises steps for adding the discrete contents of each of the plurality of ingredient packets into the baking mixture according to an ascending numerical order and a color order, and
wherein each of the one or more lower concentration ingredient packets has a lower number and a first color and each of the one or more higher concentration ingredient packets has a higher number and a second color, the color order firstly comprising the first color and secondly comprising the second color.
